(19) United States
(12) Patent Application Publication
(10) Pub. No.: US 2002/0112513 A1
(43) Pub. Date: Aug. 22, 2002

(54) Universal key stick device

(76) Inventors: Charlie Miller, Merigold, MS (US); Anna R. Jo Miller, Merigold, MS (US)

Correspondence Address: FURRER & TEZAK, P.O. Box 1629, Mukilteo, WA, 98275, US

(21) Appl. No.: 10/071,819

(22) Filed: Feb. 8, 2002

Related U.S. Application Data
(60) Provisional application No. 60/269,720, filed on Feb. 20, 2001.

(51) Int. Cl. E05B 19/04

(52) U.S. Cl. 70/408

(57) ABSTRACT

Provided in accordance with the present invention, are preferred embodiments for increasing or decreasing the lever arm on a key, specifically the bow portion of the key. The invention includes a master segment that preferably is round or oval in shape and easily griped by a user. The master segment includes a means for securing thereto a key, and at an end opposite the key, a means for securing additional segments thereto for increasing the lever arm on the key, hence the key blade. In different embodiments, the segments may be secured together using a screw or bolt that passes through the segments, or more preferably, each segment, excluding the master segment, may have a means for securing to a segment and a means for securing a segment thereto. In use the user inserts the blade portion of the key in a normal fashion and then uses the segments or Universal Key Stick to rotate the key, hence the blade portion, thereby rotating the lock or tumbler assembly.

### CROSS-REFERENCE TO RELATED APPLICATION

This application claims the benefit of U.S. Provisional Application, Ser. No. 60/269,720, filed Feb. 20, 2001.

### FIELD OF THE INVENTION

The present invention relates, generally, to a device for increasing the lever arm on a key bow for rotation of the key in a receptacle and, in particular, the invention relates to modular sections that can be added or removed to increase or decrease the lever arm on the key, respectively, according to the user's preference.

### BACKGROUND OF THE INVENTION

This present invention relates to a device, generally, for securely holding a key and providing assistance to a user for rotating the key, specifically the key blade, in a given receptacle or lock tumbler, including but not limited to, door locks, vehicle ignitions and a host of other key/receptacle combination. The invention is of particular use to individuals who may be handicapped or have infirmities making it difficult for them to turn or rotate a key in a receptacle. In addition, due to some illnesses, certain individuals may have difficulty gripping or holding the small bow area of a key to perform the necessary function of rotating the key in the receptacle; examples of such infirmities/illnesses may include arthritis, which affects a number of individual in our society.

Generally, a key is comprised of a flat or bow portion for gripping and rotation of a blade or knife portion attached thereto. The blade portion commonly has a series of notches, teeth and/or groves for mating with a given tumbler coded to accept the blade portion in a unique combination. The bow portion generally has a base or stop shoulder to gauge correct insertion of the blade portion into the tumbler.

The flat bow portion is generally sufficient for the average person of average strength to grip and rotate—hence rotate the blade portion—in a given receptacle for rotating a given lock or tumbler assembly. However, there are situation where the bow portion does not provide sufficient area or, more specifically, an appropriate lever arm for a user to rotate the blade portion in a tumbler. These situations may be external conditions such as weather conditions (i.e., cold freezing temperatures) wherein the tumbler assembly is more difficult to rotate than it would be in normal temperature conditions, or mechanical conditions wherein a tumbler assembly may be more difficult to rotate as a result of age or wear (i.e., rust, corrosion, worn teeth, etc.).

Because every situation is different and each user unique, it is difficult to find one type of key assistance device that functions universally. Accordingly, there is an advantage to a device that can be adapted simply and easily to individual applications. Specifically, some handicapped individuals may be more severe than others; hence, a longer lever arm would be of aid to those individuals. In other situation, it may only be necessary to use a short lever arm; again having a device that is easily adaptable is an advantage over current devices. Even further, as may be the case with changing temperatures or a lock/tumbler combination that has suddenly become difficult to operate, it is advantageous for a user to be able to add a modular section quickly and easily to provide additional assistance without the necessity of tools. In this regard, there is an advantage to a device that allows the user to quickly and easily lengthen or shorten the lever arm of a key, specifically a key bow.

### SUMMARY OF THE INVENTION

Provided in accordance with the present invention are modular units that can be assembled and a key secured thereto for improving the lever arm of the key. This present invention overcomes the disadvantage of relying solely on the key bow for leverage, and overcomes the disadvantages of prior devices by giving the user the ability to increase or decrease the lever arm simply by adding or removing segments, respectively.

Specifically, the present invention includes a master segment for securing a key thereto and for securing additional segments thereto. Once it is secured to the maser segment other segments can be added to reach the desired lever arm. Depending on the embodiment, the segments and the key can be held together with a common fastener, specifically, a screw or bolt longitudinally passing thorough the segments. Or, each segment, excluding the master segment, can be fitted with a male screw protrusion and a female threaded insert at opposing ends. In this way, additional segments can be added or removed by simply screwing the male portion into the female portion, eliminating the need for tools.

In this way, the user is provided with an elongated handle secured to a key for rotation of the key.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a perspective view of a first embodiment of the universal key stick, showing a first master segment with key securing means and three extension segments;

FIG. 2 illustrates a partial, schematic side view of the universal key stick of FIG. 1, showing the first master segment and a partial of the first extension segment;

FIG. 3 illustrates a perspective view of a second embodiment of the universal key stick, showing a second master segment with key securing means and three extension segments;

FIG. 4 illustrates a perspective view of a third embodiment of the universal key stick, showing a third master segment with a key securing means and three extension segments;

FIG. 5 illustrates a partial, schematic side view of the universal key stick of FIG. 4, showing the third master segment and a partial of the first extension segment;

FIG. 6 illustrates a perspective view of the third embodiment of the universal key stick, showing the third master segment with the key securing means and two extension segments;

FIG. 7 illustrates a perspective view of a fourth embodiment of the universal key stick, showing symmetric positioning of two segments about a key; and

FIG. 8 illustrates an exploded perspective view of a fifth embodiment of the universal key stick, showing a fourth master segment with a key securing means and two extension segments.

### DETAILED DESCRIPTION OF THE PREFERRED EMBODIMENTS

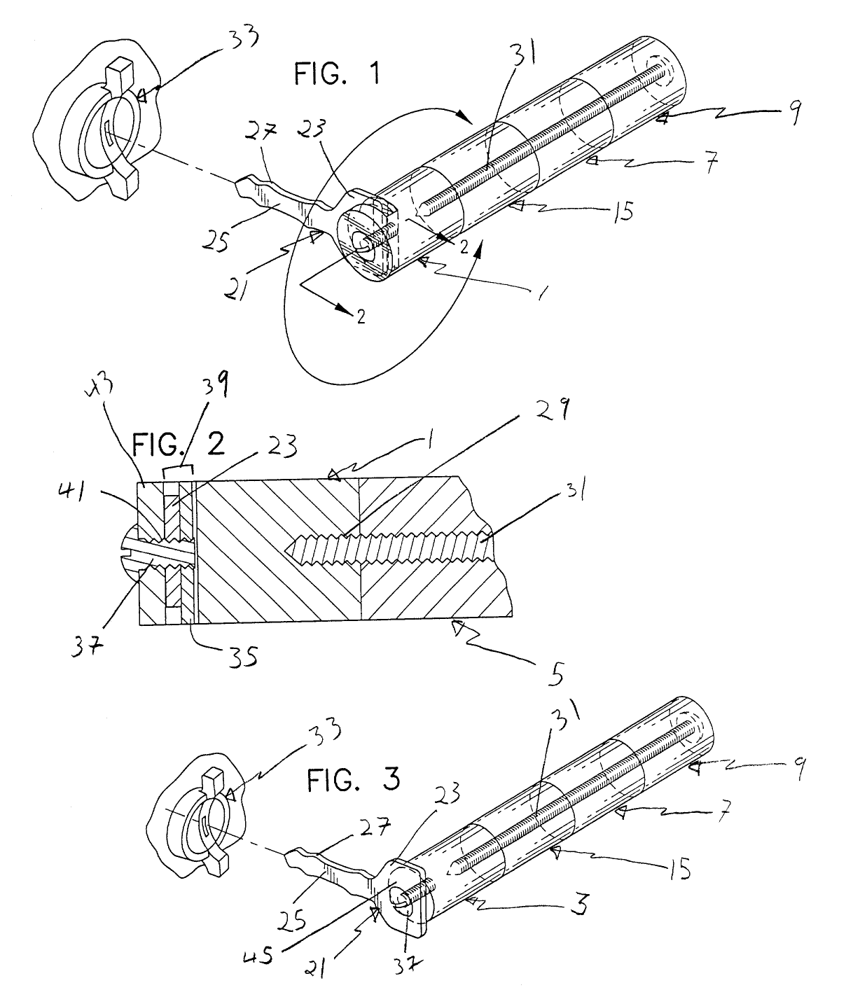

Referring now to FIG. 1 there is shown a first embodiment of a universal key stick showing a key 21 having a key bow 23 and key blade 25 with key blade teeth 27. The key 21 is presumably designed to mate with a tumbler assembly 33, wherein the key 21, when rotated, simultaneously rotates the tumbler assembly 33. The universal key stick of the first embodiment has a first master segment 1 with a key securing means (described below in reference to FIG. 2) at one end of the first master segment 1 for securing the key 21 thereto. At the opposite end of the first master segment 1 there is provided an extension securing means (described below) for securing extensions thereto, specifically, a threaded aperture 29 for threading therein a connecting screw 31, or other threaded means, for securing at least one extension segment, specifically a first extension segment 15 to the first master segment 1. The first master segment extends radically out from the key bow 23, preferably at a right angle, and provides a gripping means by which the lever arm of the key 21 is increased. Each of the extension segments, specifically, the first extension segment 15, a second extension segment 7 and a third extension segment have passing longitudinally through the centerline of each extension segment (15, 7 and/or 9) an aperture. As such, the connecting screw 31 passes through the aperture of the extension segment(s) (15, 7 and/or 9) and is threaded into the threaded aperture 29 of the first master segment 1. Based on a user's preference, extension segments (15, 7, and/or 9) can be added or removed using the connecting screw 31 securing the segments (15, 7, and/or 9) together and to the master segment 1.

FIG. 1 shows three extension segments, specifically the first extension segment 15, the second extension segment 7 and the third extension segment 9 secured to the first master segment 1. Those skilled in the art will recognized that the extension segments 15, 7 and 9 may be secured together and secured to the master segment 1 in a variety of methods in addition to using the connecting screw 31. Such methods may include, but are not necessary limited to, quick release pins, locking cams, etc. However, it is the intent of the present invention to include such methods and more importantly to disclose a means for increasing and decreasing a lever arm on the key 21 by adding and removing segments 15, 7 and 9, respectively, in accordance with the user's preference.

FIG. 2 shows a schematic side view of the first master segment 1 and a partial of the first extension segment 15. The first master segment 1 includes a movable threaded plate 35 slidably fitted into a notch 39 of an end of the first master segment 1. Accordingly, the key bow 23 is placed into the notch 39 such that a securing screw 37 can pass, first through an aperture 41 in the end of the first master segment 1, then through an aperture (not shown) of the key bow 23 and subsequently then be threading into the threaded plate 35 for securing the key 21 securely to the master segment 1. In this regard, when the securing screw 37 is tightened into the threaded plate 35, the threaded plate 35 is drawn against one side of the key bow 23 forcing the key bow 23 against a fixed portion 43 of the first master segment 1 thereby firmly securing the key bow 23, hence the key 21, to the universal key stick. Once secured, the lever arm of the key 21 has been increased.

The second embodiment shown in FIG. 3 includes a second master segment 3. The second master segment 3, while similar to the first master segment 1, eliminates the notch 39 and moveable threaded plate 35 and merely secures the key bow 23 to an end 45 of the second master segment 3. The key bow 23 is secured to the end 45 using the securing screw 37 which passes through the aperture (not shown) of the key bow 23 and into the threaded aperture 29 of the second master segment 3. When the securing screw 37 is tightened, the securing screw 37 firmly secures the key 23 to the second master segment 3. As in first embodiment of the universal key stick shown in FIG. 1, the second embodiment may include, in addition to the second master segment 3, the first extension segment 15, the second extension segment 7 and/or the third extension segment 9 for increasing (or decreasing if removed) the lever arm on the key bow 23 for rotating the tumbler assembly 33 according to the user's preference.

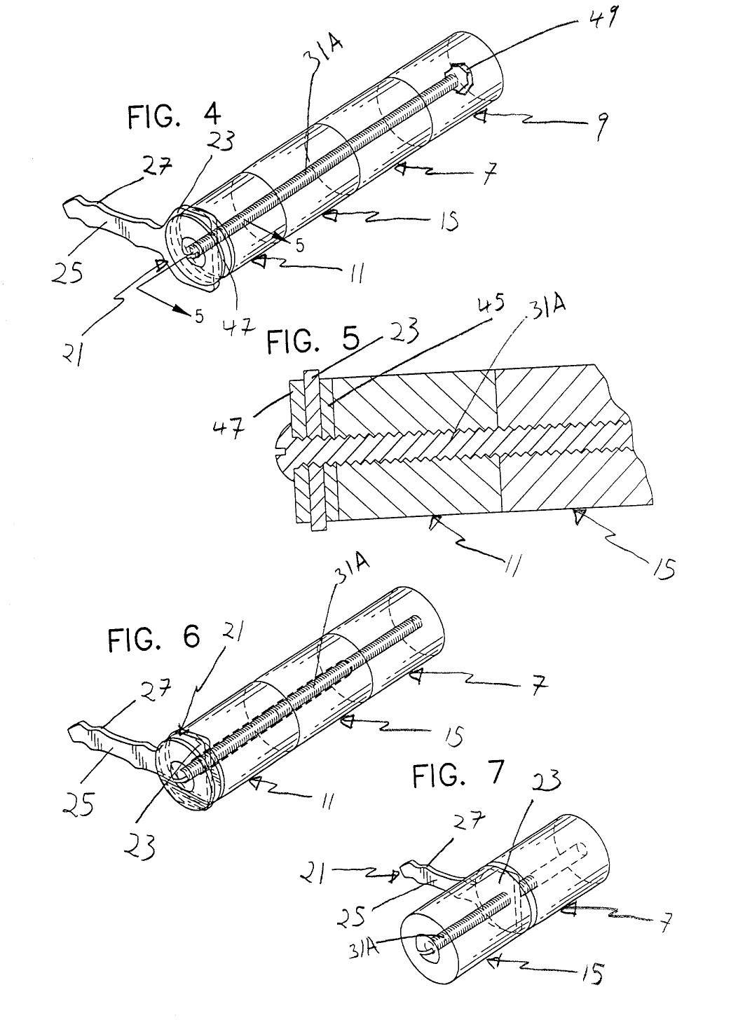

Referring now to FIG. 4, there is shown a third master segment 11 having secured thereto the first extension segment 15, the second extension segment 7 and the third extension segment 9. The third embodiment shown in FIG. 4 differs from the first and second embodiments in that the third master segment 11 is identical to the extension segments (15, 7 and 9). In this regard, the key bow 23 is sandwiched between a washer 47 and an end of the third master segment 11. A connecting screw 3 1A passes through the longitudinal center of the third master segment 11 and through the longitudinal centers of the extension segments (15, 7 and/or 9) attached thereto (i.e., the first extension segment 15, the second extension segment 7 and/or the third extension segment 9). The advantages of the third embodiment shown in FIG. 4 are that the third master segment 11 is identical and interchangeable with the extension segments (15, 7 and 9). In this regard, assembly is simplified and the universal key stick is not rendered inoperable if, for example, the third master segment 11 is lost, misplaced and/or damaged.

The partial, schematic side view shown in FIG. 5 shows the key bow 23 sandwiched between the end 45 of the third extension segment 11 and the washer 47. The force necessary to hold the key bow 23 in place is provided by the screw 31 A passing through at least the third master segment and, according to the user's preference, additional extension segments (15, 7 and/or 9). By tightening a nut 49 on the connecting screw 31 A the third master segment 11 and the extension segments (15, 7, and/or 9) are securely held together. While this disclosure is intended to present the preferred embodiment of the present invention, it will be readily apparent to those skilled in the art that various means and methods may be adopted to increase the lever arm on a key wherein such means and methods include segments that can be added or removed to increase or decease the lever arm, respectively, according to the user's preference.

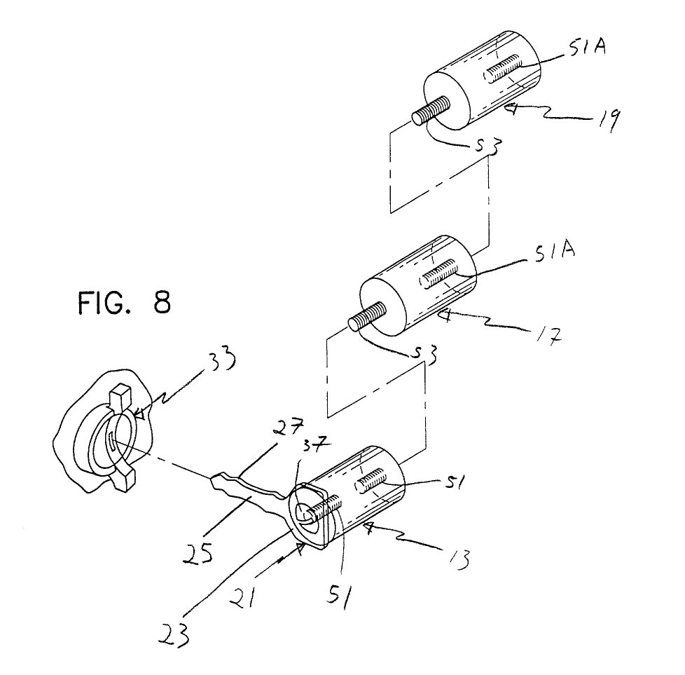

The universal key sticks shown in FIG. 6 and FIG. 7 show variations that can be achieved by arranging the third master segment 11 and at least one of the extension segments (15, 7, and/or 9) according to the user's preference. Specifically, FIG. 6 shows the third master segment 11 combined with the first extension segment 15 and the second extension segment 7. In this configuration, the total lever arm on the key bow 23 is less that that shown in FIG. 4 wherein the third extension segment 9 is also added. It should be apparent to those skilled in the art that, like FIG. 6 shows, the opposite is similarly true in that more than the three extension segments (15, 7, and 9) shown in FIG. 4 can be added if it is the desire of the user to increase the lever arm on the key bow 23 even further. Also, the user could choose to have only the master segment (1, 3 or 11) secured to the key bow 23 thereby only slightly increasing the lever arm on the key bow 23.

Alternatively, FIG. 7 shows a symmetrical configuration for the universal key stick wherein an extension segment (15, 7 and/or 9) may be placed on one side of the key bow 23 and another extension segment (15, 7, and/or 9) or the third master segment 11, may be placed on the other side thereby sandwiching the key bow 23 between two segments (15, 7 and/or 9). This configuration provides an alternative method for increasing the lever arm on the key bow 23 that may be preferable for the user.

Yet a fourth embodiment of the universal key stick is shown in the exploded perspective view of FIG. 8. While the fourth master segment 13 is shown, variations of the first master segment 1, the second master segment 3 and the third master segment 11 can be altered, as would be readily apparent to those skilled in the art, to function in accordance with this fourth embodiment. For simplicity and description, the master segment 13 will be identified. The fourth embodiment includes the fourth master segment 13 having threaded apertures 51 in both ends of the fourth master segment 13. The securing screw 37 passes through an aperture (not shown) in the key bow 23 and is securely tightened into the threaded aperture 51 of the fourth master segment 13-in this regard, the key 21 is firmly secured to the fourth master segment 13. Each of the extension segments, specifically, a first alternative extension segment 17 and a second alternative extension segment 19, includes a threaded stud 53 and a threaded aperture 51A. In this regard, extension segments (17 and/or 19) can be added by screwing the threaded stud 53 into the threaded aperture 51, first of the fourth master segment 13 and then, if additional extension segments are required, into the threaded aperture 51 A of the extension segment(s) (17 and/or 19).

While preferred embodiments of the invention have been illustrated and described, it will be appreciated that various changes can be made therein while remaining within the scope of the invention. Since changes can be made to the described embodiments of the invention, the invention should be defined only by reference to the claims of the invention.

The embodiments of the invention in which an exclusive property or privilege is claimed are defined as follows:

1. A device for securing a key thereto to increase a lever arm of the key, the key having a key aperture therein, comprising:
(a) a master segment for securing the key thereto and extending radically from the key, said master segment being readily gripped by a user of said key;
(b) a key securing means at one end of the master segment for securing said key firmly to the master segment, wherein when the master segment is rotated about an axis of the key, the key is simultaneously rotated; and
(c) an extension securing means at an end of the master segment opposite the end of the master segment having the key securing means, for securing thereto extension segments wherein the lever arm of the key can be further increased.

2. The device according to claim 1 wherein the master segment further comprises a threaded bore wherein the extension securing means is a threaded fastener extending through a bore in the extension segment and threaded into the threaded bore of the master segment.

3. The device according to claim 1 wherein the master segment further comprises a bore extending longitudinally through a center of the master segment wherein the key securing means and the extension securing means are combined in a common securing means that extends through the key aperture, then through the bore of the master segment, and then through the bore of the extension segment thereby firmly securing the key to the master segment and the master segment to the extension segment.

4. The device according to claim 3 wherein said common securing means is of sufficient length to extend through a plurality of extension segments, said key being secured to one end of the plurality of segments, specifically one end of the master segment, by the common securing means.

5. The device according to claim 4 wherein the master segment and the extension segment are identical, and further wherein the key is secured to one end of the master segment by sandwiching the key between a washer and the end of the master segment, the washer having an aperture wherein the common securing means is of sufficient length to pass through the aperture in the washer, then through the aperture in the key, then through the bore of the master segment, then through the bore of the extension segment thereby firmly securing the key to the master segment and the master segment to the extension segment.

6. A device for securing a key thereto to increase a lever arm of the key, the key having an aperture therein, comprising:
a) a master segment for securing the key thereto and extending radically from the key, said master segment being readily gripped by a user of said key, the master segment having a threaded bore on each end of the master segment;
b) a key securing means at one end of the master segment for securing said key firmly to the master segment, said key securing means comprising a threaded fastener for passing through an aperture of said key and securely threading into one of said threaded bores in said end of said master segment; and
c) an extension securing means at an end of the master segment opposite the end of the master segment having the key securing means, for securing thereto extension segments wherein the lever arm of the key can be further increased.

7. The device according to claim 7 wherein the extension securing means comprises a threaded fastener for securely threading into one of said threaded bores in said end of said master segment, said threaded bore being at an opposite end of the master segment as the key securing means, the threaded fastener being securely attached to an end of the extension segment.

8. The device according to claim 7 wherein the extension segment has at one end a threaded protrusion for mating with the threaded bore in the master segment opposite the end of the master segment as the key securing means, wherein said extension segment can be secured to the master segment by threading the threaded protrusion into the threaded bore, and further wherein the extension segment has at an opposite end of the threaded protrusion a threaded bore for receiving a threaded protrusion of a subsequent extension segment.

9. The device according to claim 8 further comprising a plurality of extension segment.
